(19) United States
(12) Patent Application Publication
(10) Pub. No.: US 2009/0092047 A1
(43) Pub. Date: Apr. 9, 2009

(54) SYSTEM TO MANAGE MULTILAYER NETWORKS

(76) Inventors: Steven Gemelos, San Jose, CA (US); Peter A. Wong, Newark, CA (US); Orestis Manthoulis, Sausalito, CA (US)

Correspondence Address: SCHWEGMAN, LUNDBERG & WOESSNER, P.A., P.O. BOX 2938, MINNEAPOLIS, MN, 55402, US

(21) Appl. No.: 11/868,589

(22) Filed: Oct. 8, 2007

(51) Int. Cl. G08C 15/00

(52) U.S. Cl. 370/235

(57) ABSTRACT

A system includes a capacity management tool. The capacity management tool is configured to be coupled to one or more of an application layer, a physical layer, and a transport layer of a processor-based network. In a particular embodiment, the capacity management tool is further configured to extract data from one or more of a network connectivity database, a customer provisioning and services ordered database, a customer equipment database, a network element management system database, and a server and application management system database. The capacity management tool can be further configured to correlate the data to manage the capacity of the network or isolate congestion points in the network.

### TECHNICAL FIELD

The present disclosure relates to computer-based networks, and in an embodiment, but not by way of limitation, a system to manage multilayer networks.

### BACKGROUND

Processor-based networks have become ubiquitous in all walks of life. One type of network is a multi-layer network. Multi-layer networks normally include a physical layer, a transport layer, and an application layer. The connectivity and inter-functionality of these multiple layers, and elements within the layers, can become very complex. This complexity, if not properly managed, can lead to a degradation of the quality of service in the network.

### BRIEF DESCRIPTION OF THE DRAWINGS

Some embodiments are illustrated by way of example, and not by way of limitation, in the figures of the accompanying drawings in which:

FIG. 1 illustrates an example network system including a capacity management tool.

FIG. 2A illustrates an example of a multi-layer network.

FIG. 2B illustrates another example of a multi-layer network.

FIG. 3 illustrates a flowchart of an example process for managing a multi-layer network.

FIG. 4 is a diagrammatic representation of a machine in an example form of a computer system within which is a set of instructions for causing the machine to perform any one or more of the methodologies described herein in FIGS. 1-3.

### DETAILED DESCRIPTION

An example system, method and machine readable medium for managing multilayer networks are described.

In accordance with an example embodiment, there is provided a method, system, and machine readable medium for managing a multi-layer network. In an example embodiment, the system includes a capacity management tool. The capacity management tool is configured to be coupled to one or more of an application layer, a physical elements layer, a physical layer, an IP packet layer, and a transport layer of a processor-based network. In a particular embodiment, the capacity management tool is further configured to extract data from one or more of a network connectivity database; a customer provisioning and services ordered database; a customer equipment database; a capacity management database; a network element management system database; a server and application management system database; and a network equipment database. The capacity management tool can be further configured to correlate the data to manage the capacity of the network or isolate congestion points in the network.

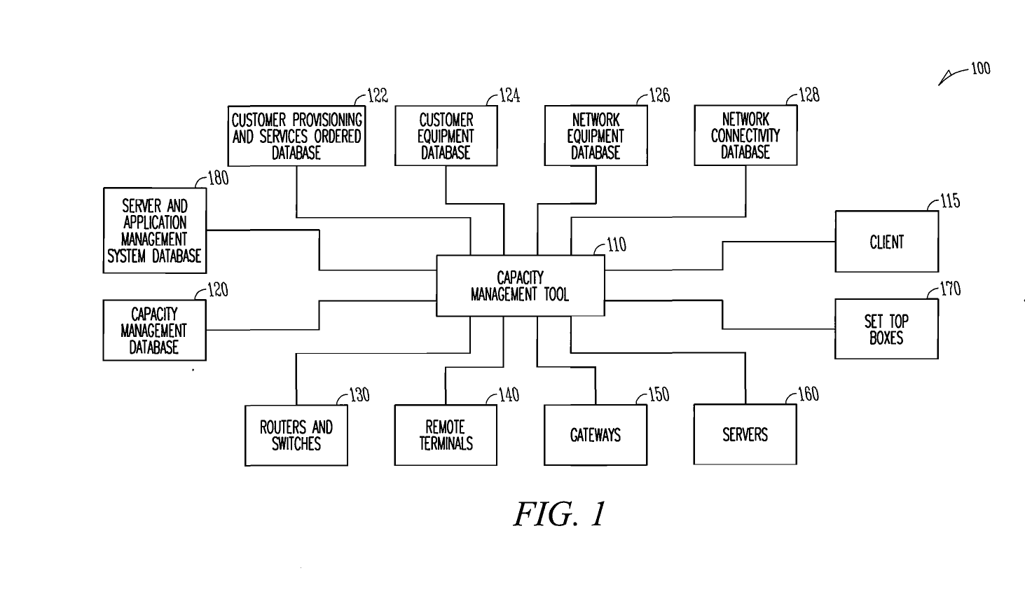

FIG. 1 illustrates an example embodiment of a network 100. The network 100 includes a capacity management tool 110. A client 115 is connected to the capacity management tool 110. The capacity management tool 110 has access to and is coupled to a plurality of other network components, devices, and databases. The capacity management tool 110 is connected to a capacity management database 120. The capacity management database 120 contains data from many other of the databases, devices, and elements in the network 100. The capacity management database 120 basically serves as a local store of data for the capacity management tool 110, wherein such data can include packets transmitted, packets lost, data on a specific customer, server CPU utilization, and server memory utilization. The capacity management tool 110 is further connected to a customer provisioning and services ordered database 122, a customer equipment database 124 containing data relating to the equipment associated with each customer such as an identification of lines and switches associated with a particular customer, a network equipment database 126 containing data relating to all the equipment in the entire network such as copper and fiber connections inventory, and a network connectivity database 128 containing data relating to such things as a node location, a type of node, and equipment associated with a node. The term customer provisioning refers to any information that relates to a customer's service. For example, for DSL services, customer provisioning data can include whether the customer is an individual or a business, the line speed of the service, and other DSL related data that is used to configure the customer's equipment. For an Internet Protocol Television (IPTV) service, the data can include for example the identification of the services associated with that customer such as Internet, video, and VoIP. The capacity management tool 110 is further connected to other network elements such as routers and switches 130, remote terminals (e.g., a Digital Subscriber Line Access Multiplexer (DSLAM)) 140, gateways 150, servers 160, and Set Top Boxes 170. The routers, switches, remote terminals, and gateways are considered part of a network element management system database. A server and application management database 180 contains data relating to such things as the Microsoft Operations Manager (MOM).

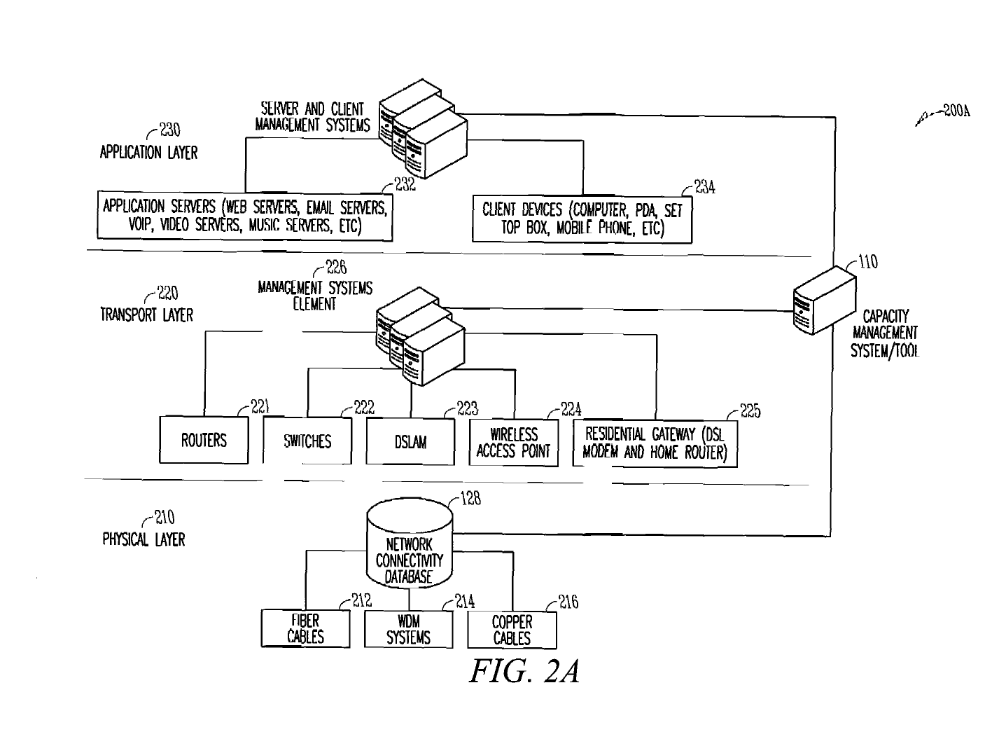

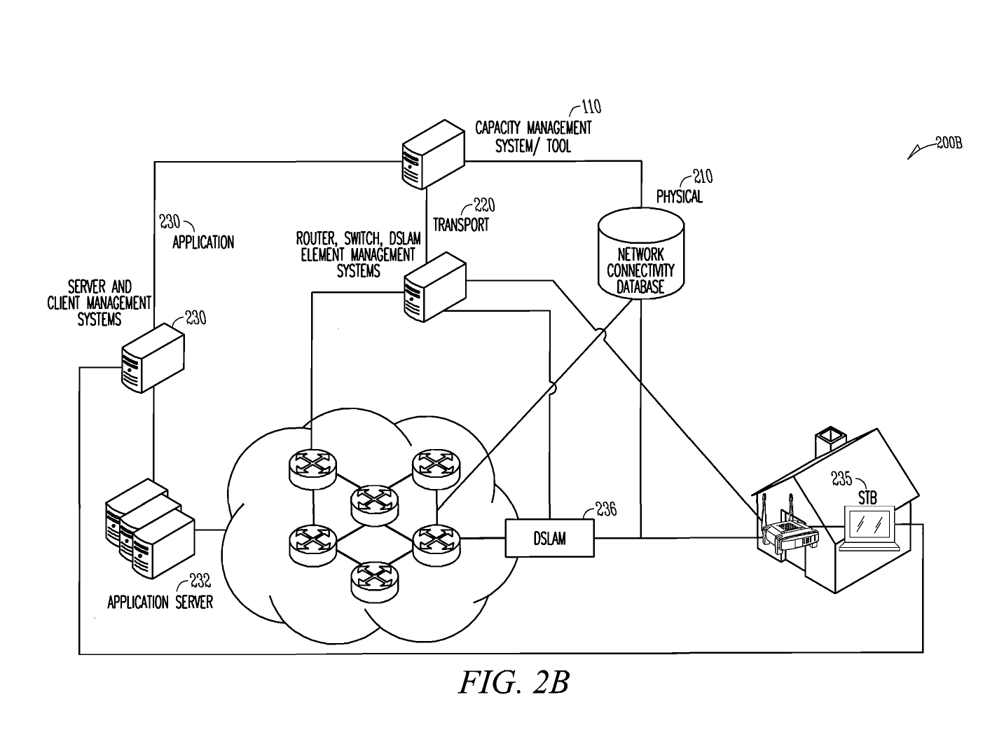

FIG. 2A illustrates an example of a multi-layer network 200A including a physical layer 210, a transport layer 220, and an application layer 230 of a processor-based network. Physical layer 210 includes fiber cables 212, wavelength division multiplex systems (WDM) 214, and copper cables 216, all of which are coupled to the network connectivity database 128. The transport layer 220 includes routers 221, switches 222, DSLAMs 223, wireless access points 224, and residential gateways (DSL modem and home router) 225. These elements of the transport layer 220 are managed by an element management system 226. The application layer 230 can include application servers 232 (e.g., web servers, email servers, VoIP, video servers, and music servers) and client devices 234 (e.g., computers, PDAs, set-top boxes, and mobile phones). FIG. 2A further illustrates how the physical layer 210, the transport layer 220, and the application layer 230 couple to the capacity management tool 110.

FIG. 2B illustrates another example of a multi-layer network 200B. FIG. 2B illustrates the physical layer 210, the transport layer 220, and the application layer 230, and the coupling of the capacity management tool 110 to these layers. FIG. 2B further illustrates that the application layer is coupled to application servers 232 (such as IPTV servers). The IPTV application servers 232 can be coupled to a customer device such as a set-top box 235 through transport layer 220 and the physical layer 210 (which can include a DSLAM 236).

The capacity management tool 110 correlates the performance and capacity information collected from these many network databases, network elements, and application servers. This information originates from the physical layer, the IP layers, the transport layer, and the server and application layers. This information is used to determine not only the capacity or performance of the network, but also the quality of service being provided to the customer.

The capacity management tool 110 monitors, analyzes, and manages the capacity in a network in real time (for isolating problems) and long term (for network capacity planning). In doing so, the capacity management tool monitors and analyzes many layers in a network. The monitored and analyzed layers can include the physical elements (routers, line cards, ports, switch cards, servers, residential gateways, set top boxes), the physical layer (fiber and copper physical links), the transport layer (Ethernet, DSL, and SONET), the IP packets (TCP, UDP, Unicast, Multicast, and Broadcast), and the application layer (including servers providing IPTV services (A-Servers, D-Servers, client-facing servers, database servers)). Moreover, the capacity management tool 110 monitors the quality of service (QOS) for each type of traffic in the network (voice, video, data, and network management), and the QOS for each type of traffic for each customer. This is done based on either the DSCP or p-bit markings of each queue.

The capacity management tool 110 can monitor and analyze the entire network end to end, from the servers and clients, all the way down to the fiber and copper interconnects, and all the routing and quality assurance products. The capacity management tool 110 further correlates all the information across the network to validate a customer's quality of service or a capacity issue in the network.

The capacity management tool 110 uses the data from the databases 120-128 to manage the network 100. The types of data used by the capacity management tool include primarily network architecture information and customer information. The network information includes such things as node (or office) locations. The location information can include the region of the location, the metropolitan area, and the distribution market area. The location information further can include the CLLI (Common Language Location Identification) code identifier of a particular office location. The location information can further include a type of node associated with the node location such as a Super Headend Office (SHO), a Video Home Office (VHO), an Intermediate Office (IO), a Central Office (CO), or a Service Area Interface (SAI). The node information can further include the equipment that is associated with that node (e.g., routers, switches, DSLAMs, and servers), and the connectivity between nodes and the hierarchical associations of the nodes.

The customer information can include data such as customer identification, the equipment associated with a customer (or that a customer has in his residence) such as an Optical Network Unit (ONU) (e.g., for a Passive Optical Network) (PON)), a residential gateway, or a Set Top Box (STB). The customer information can include separate account information for voice, video, and data services. The customer information can further include account and service configuration information that can include the serial numbers and identifiers for all the equipment in the customer's residence (Residential Gateway (RG) and Set-Top Box (STB)), connection information regarding the RG to the DSLAM (e.g., the specific port information on the DSLAM), the IP address of the RG on the network, and the Virtual Local Area Network (VLAN) tags associated with the customer's service through the access network.

The capacity management tool 110 uses the network architecture and customer information and can construct the physical connectivity of the network by region, identify a specific customer's circuit (e.g., STB, RG, DSLAM port, VLAN, etc.), and can then track the customer's service through the network.

From the network equipment and connectivity databases and the network element management system databases, the capacity management tool 110 can obtain performance and capacity information about each of the network elements (e.g., STB, RG, DSLAM, routers, switches, servers, and applications). Moreover, the capacity management tool 110 can obtain this information on many different levels such as the physical level, logical level, physical layer network connectivity, transport layer, IP layer, and quality of service layer (QOS layer) per service performance.

For the physical elements, inventory and availability information is maintained and used to manage the network. This information can include the CLLI code, total number of slots, occupied slots, and available slots, card types per slot, ports per card type, occupied ports, and available ports. In addition to the physical inventory information, resource information is collected relating to CPU and memory utilization, total number of VLANs (Viritual Private Lan Services (VPLSs)) configured (each router/switch has a limited number of VLANs that can be supported), and the number of service access points (SAPs) per VPLS (each router switch has a limit on the number of ports per VLAN or VPLS). This physical inventory information and resource information is tracked by the capacity management tool 110 to determine whether the system is reaching a physical or logical capacity limit.

Regarding the physical layer, the connectivity between each of the elements in a network is maintained. This can include the connections between servers and routers, connections between routers and switches, and connections between the network nodes (SHO, VHO, 10, CO, SAI, and RG).

At the transport and IP layers, several metrics are collected and analyzed to determine the performance of the network. For the transport layer, data are collected from the network elements for each link including Ethernet frame count, loss, errors, pauses, DSL state, sync, bit rate up/down, and utilization up/down. For the IP layer, the network elements data can include the IP packets that were transmitted and/or received, the unicast packets that were transmitted and/or received, the multicast packets that were transmitted and/or received, the broadcast packets that were transmitted and/or received, and error/lost packets that were transmitted and/or received. Data relating to these can be expressed in bytes so that bandwidth utilization can be analyzed.

For a determination of the quality of service of a network, the capacity management tool 110 collects data from each network element based on packet markings and the queues that the router places the packets in based on those markings (DSCP or p-bits). In one embodiment, these queues and markings differentiate the services in the network such as voice, video, and data. Each queue is checked for packet throughput, errors, and loss. From this throughput, error, and loss data, the capacity management tool 110 determines a measure of the quality of the transport of the packets for each service.

In addition to collecting all of this information about the network, the capacity management tool 110 correlates this information to determine the quality of the service being provided to the customer. For example, using the information retrieved for a particular customer service, the capacity management tool 110 can track that service through each network element, network port, and logical network layers to determine if a customer's packets are being transported correctly or are being lost in the network due to faults or congestion of the network resources. The capacity management tool 110 can also correlate performance of the service per customer (or per router/switch or any of the aforementioned metrics) and aggregate these to provide an overview of the performance, health, and capacity limits of the network by SAI, CO, IO-pair, DMA, VHO, region, or for the overall network.

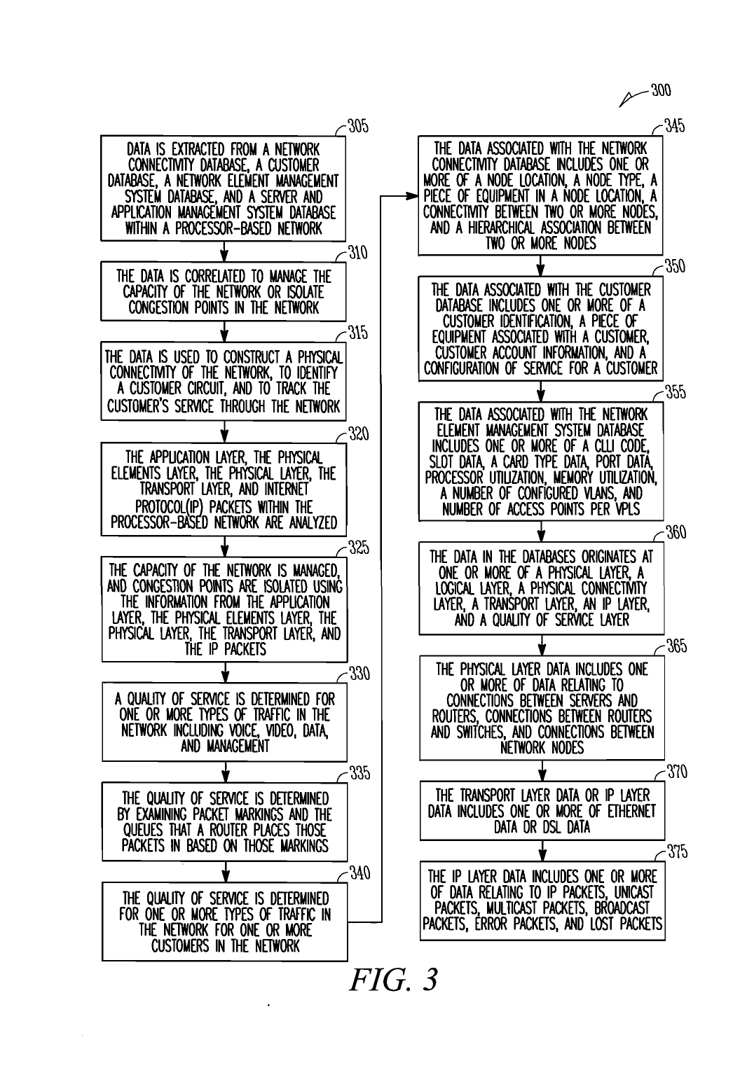

FIG. 3 is a flowchart of an example process 300 for managing a multi-layer network. FIG. 3 includes a number of process blocks 305-375. Though arranged serially in the example of FIG. 3, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

At 305, data is extracted from one or more of a network connectivity database, a network equipment database, a capacity management database, a customer provisioning and services ordered database, a customer equipment database, a network element management system database, a network connectivity database, a network equipment database, a capacity management database, and a server and application management system database within a processor-based network. At 310, the data is correlated to manage the capacity of the network or isolate congestion points in the network. At 315, the data is used to construct a physical connectivity of the network, to identify a customer circuit, and to track the customer's service through the network. At 320, one or more of the application layer, the physical elements layer, the physical layer, the transport layer, and Internet Protocol (IP) packet layer within the processor-based network are analyzed. At 325, the capacity of the network is managed, and congestion points are isolated using the information from one or more of the application layer, the physical elements layer, the physical layer, the transport layer, and the IP packet layer. At 330, a quality of service is determined for one or more types of traffic in the network including voice, video, data, and network management. At 335, the quality of service is determined by examining packet markings and the queues that a router places those packets in based on those markings. At 340, the quality of service is determined for one or more types of traffic in the network for one or more customers in the network. At 345, the data associated with the network connectivity database includes one or more of a node location, a node type, a piece of equipment in a node location, a connectivity between two or more nodes, and a hierarchical association between two or more nodes. At 350, the data associated with the customer provisioning, equipment, and services ordered databases include one or more of a customer identification, a piece of equipment associated with a customer, customer account information, and a configuration of service for a customer. At 355, the data associated with the network element management system database includes one or more of a CLLI code, slot data, card type data, port data, processor utilization, memory utilization, a number of configured VLANS, and a number of access points per VPLS. At 360, the data in the databases originates at one or more of a physical layer, a logical layer, a physical connectivity layer, a transport layer, an IP layer, and a quality of service layer. At 365, the physical layer data includes one or more of data relating to connections between servers and routers, connections between routers and switches, and connections between network nodes. At 370, the transport layer data or IP layer data includes one or more of Ethernet data or DSL data. At 375, the IP layer data includes one or more of data relating to IP packets, unicast packets, multicast packets, broadcast packets, error packets, and lost packets.

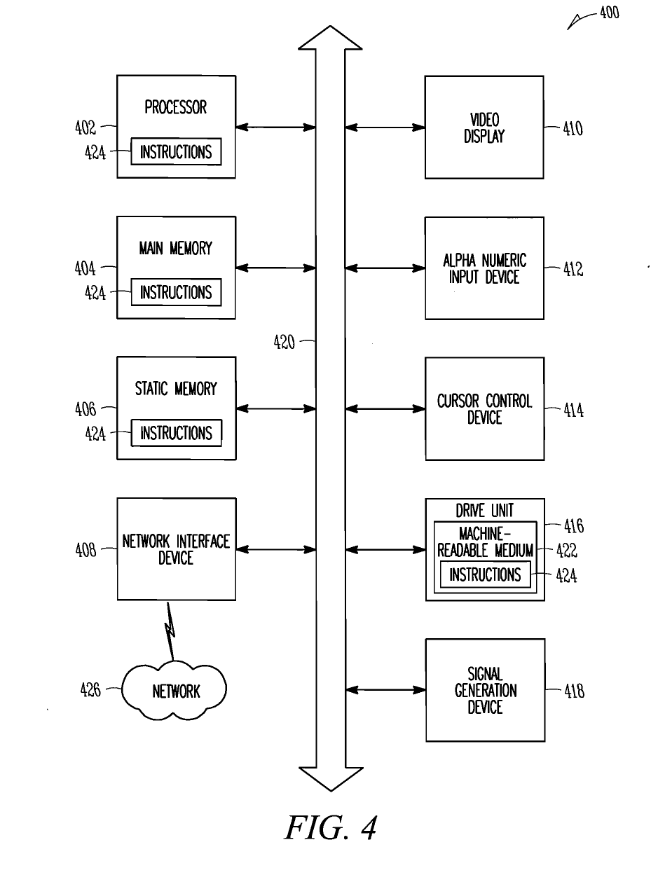

FIG. 4 is a diagrammatic representation of machine in an example form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Further with reference to FIG. 4, the example computer system 400 includes a processor 402 (e.g., a central processing unit (CPU), a graphics processing unit (GPU) or both), a main memory 404 and a static memory 406, which communicate with each other via a bus 420. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 408.

Still further with reference to FIG. 4, the disk drive unit 416 includes a machine-readable medium 422 on which is stored one or more sets of instructions and data structures (e.g., software 424) embodying or utilized by any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media. The software 424 may further be transmitted or received over a network 426 via the network interface device 408 utilizing any one of a number of well-known transfer protocols (e.g., HTTP).

Lastly with reference to FIG. 4, while the machine-readable medium 422 is shown in the example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of an example embodiment, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules can be implemented as hardware circuitry, optical components, single or multi-processor circuits, memory circuits, software program modules and objects, firmware, and combinations thereof, as appropriate for particular implementations of various embodiments.

Thus, an example system, method and machine readable medium for managing a multi-layer network has been described. Although specific example embodiments have been described, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a capacity management tool, the capacity management tool configured to be coupled to an application layer, a physical layer, and a transport layer of a processor-based network;
wherein the capacity management tool is further configured to extract data from a plurality of a network connectivity database, a customer provisioning and services ordered database, a customer equipment database, a network equipment database, a capacity management database, a network element management system database, and a server and application management system database;
wherein the capacity management tool is further configured to correlate the data across the application, the physical, and the transport layers of the network to manage the capacity of the network or to isolate congestion points in the network.

2. The system of claim 1, wherein the capacity management tool is further configured to use the data to construct a physical connectivity of the network, identify a customer circuit, and track the customer's service across the application, the physical, and the transport layers of the network.

3. The system of claim 1, wherein the capacity management tool is further configured to analyze and monitor the application layer, the physical layer, and the transport layer within the processor-based network.

4. The system of claim 1, wherein the capacity management tool is further configured to manage the capacity of the network and isolate congestion points using the information from the application layer, the physical layer, and the transport layer.

5. The system of claim 1, wherein the capacity management tool is further configured to determine a quality of service for one or more types of traffic in the network including voice traffic, video traffic, data traffic, and network management traffic.

6. The system of claim 5, wherein the capacity management tool is further configured to determine the quality of service by examining packet markings and the queues in which a router places packets as a function of the markings.

7. The system of claim 1, wherein the capacity management tool is further configured to determine the quality of service for one or more types of traffic in the network for one or more customers in the network.

8. The system of claim 1, wherein the data associated with the network connectivity database include one or more of a node location, a node type, a piece of equipment in a node location, a connectivity between two or more nodes, and a hierarchical association between two or more nodes.

9. The system of claim 1, wherein the data associated with the customer provisioning and services ordered database and the customer equipment database include one or more of a customer identification, a piece of equipment associated with a customer, customer account information, and a configuration of service for a customer.

10. The system of claim 1, wherein the data associated with the network element management system database include one or more of a CLLI code, slot data, card type data, port data, processor utilization, memory utilization, a number of configured VLANS, and a number of access points per VPLS.

11. The system of claim 1, wherein the data associated with the capacity management database include data from one or more of the network connectivity database, the customer provisioning and services ordered database, the customer equipment database, the network equipment database, the network element management system database, and the server and application management system database.

12. The system of claim 1, wherein the data in the databases originate from the physical layer, the transport layer, the application layer, a logical layer, a physical connectivity layer, an IP layer, and a quality of service layer.

13. The system of claim 12 wherein the physical layer data includes one or more of data relating to connections between servers and routers, connections between routers and switches, and connections between network nodes.

14. The system of claim 12, wherein the transport layer data include one or more of Ethernet data or DSL data.

15. The system of claim 12, wherein the IP layer data include one or more of data relating to IP packets, unicast packets, multicast packets, broadcast packets, error packets, and lost packets.

16. A computer-readable medium comprising instructions for:
extracting data from a plurality of a network connectivity database, a customer provisioning and services ordered database, a customer equipment database, a network equipment database, a capacity management database, a network element management system database, and a server and application management system database;
correlating the data to manage the capacity of a network or isolate congestion points in a network; and
constructing a physical connectivity of the network across all layers of the network to identify a customer circuit and to track the customer's service across all layers of the network.

17. The computer-readable medium of claim 16, comprising instructions for analyzing the physical layer, the transport layer, or the application layer.

18. The computer-readable medium of claim 16, comprising instructions for managing the capacity of the network and isolating congestion points using data from the physical layer, the transport layer, and the application layer.

19. The computer-readable medium of claim 16, comprising instructions for determining a quality of service of one or more types of traffic in the network including voice, video, and data.

20. The computer-readable medium of claim 16, comprising instructions for determining a quality of service of the network by examining packet markings and queues in which a router places packets.

21. The computer-readable medium of claim 16, wherein the computer-readable medium is associated with a set-top box.

22. A process comprising:
extracting data from a plurality of a network connectivity database, a customer provisioning and services ordered database, a customer equipment database, a network equipment database, a capacity management database, a network element management system database, and a server and application management system database;
correlating the data to manage the capacity of a network or isolate congestion points in a network; and
constructing a physical connectivity of the network across all layers of the network to identify a customer circuit and to track the customer's service across all layers of the network.

23. The process of claim 22, comprising managing the capacity of the network and isolating congestion points using data from the physical layer, the transport layer, and the application layer.

24. The process of claim 22, comprising determining a quality of service of one or more types of traffic in the network including voice, video, and data.

25. The process of claim 22, comprising determining a quality of service of the network by examining packet markings and queues in which a router places packets.
